(19) United States
(12) Patent Application Publication
(10) Pub. No.: US 2025/0055300 A1
(43) Pub. Date: Feb. 13, 2025

(54) POWER CONVERTERS AND METHODS FOR CHARGING AND DISCHARGING A BATTERY

(71) Applicant: Murata Manufacturing Co., Ltd., Kyoto (JP)

(72) Inventor: David GIULIANO, Bedford, NH (US)

(21) Appl. No.: 18/446,462

(22) Filed: Aug. 8, 2023

(51) Int. Cl. H02J 7/00; H02M 3/07; H02M 3/158

(52) U.S. Cl. CPC H02J 7/007182; H02J 7/0071; H02M 3/07; H02M 3/158; H02J 2207/20

(57) ABSTRACT

A power converter for use with a programmable power supply circuit includes a charging circuit and a battery. The charging circuit is electrically coupled to the programmable power supply circuit, the programmable power supply circuit being configured to provide a regulated DC input voltage. The charging circuit includes a first dc-dc converter electrically coupled to the programmable power supply circuit and configured to convert the regulated DC input voltage to a system output voltage at an output node. The battery is electrically coupled to the first dc-dc converter, and configured to be charged or discharged, directly or indirectly via the output node. The charging circuit further includes a second dc-dc converter electrically coupled in series between the programmable power supply circuit and the battery. One of the first dc-dc converter and the second dc-dc converter is an unregulated converter.

### TECHNICAL FIELD

The present disclosure generally relates to power electronic devices. More particularly, the present disclosure relates to DC-DC power converters.

### BACKGROUND

Nowadays, many electronic products, such as mobile computing devices and/or communication products (e.g., smart phones, notebook computers, ultra-book computers, tablet devices, etc.) may support various charging schemes. For example, some electronic devices may enable a high-speed charging function using a relative high output power to rapidly charge the battery in the electronic devices to provide better user experience, or enable a maintenance charging mode using a low output power to extend the battery life and avoid the degradation of the battery. To support charging schemes for different applications or system conditions, the battery chargers need to adjust the output voltage and/or current dynamically in response to commands from the electronic products. Accordingly, it has become a critical challenge in the field to design high-efficiency power conversion circuits and battery charging topologies for the battery chargers to improve the charging capability and the circuit design flexibility, and to meet the power requirements for electronic products.

### SUMMARY

Embodiments of the present disclosure provide a power converter for use with a programmable power supply circuit. In some embodiments, the power converter includes a charging circuit and a battery. The charging circuit is electrically coupled to the programmable power supply circuit, the programmable power supply circuit being configured to provide a regulated DC input voltage. The charging circuit includes a first dc-dc converter electrically coupled to the programmable power supply circuit and configured to convert the regulated DC input voltage to a system output voltage at an output node. The battery is electrically coupled to the first dc-dc converter, and configured to be charged or discharged, directly or indirectly via the output node. The charging circuit further includes a charger transistor electrically coupled in series between the first dc-dc converter and the battery via the output node and configured to enable or disable charging or discharging of the battery.

In some embodiments, the power converter includes a charging circuit and a battery. The charging circuit is electrically coupled to the programmable power supply circuit, the programmable power supply circuit being configured to provide a regulated DC input voltage. The charging circuit includes a first dc-dc converter electrically coupled to the programmable power supply circuit and configured to convert the regulated DC input voltage to a system output voltage at an output node. The battery is electrically coupled to the first dc-dc converter, and configured to be charged or discharged, directly or indirectly via the output node. The charging circuit further includes a second dc-dc converter electrically coupled in series between the programmable power supply circuit and the battery. One of the first dc-dc converter and the second dc-dc converter is an unregulated converter.

In some embodiments, the power converter includes a charging circuit and a battery. The charging circuit is electrically coupled to the programmable power supply circuit, the programmable power supply circuit being configured to provide a regulated DC input voltage. The charging circuit includes a first dc-dc converter electrically coupled to the programmable power supply circuit and configured to convert the regulated DC input voltage to a system output voltage at an output node. The battery is electrically coupled to the first dc-dc converter, and configured to be charged or discharged, directly or indirectly via the output node. The charging circuit further includes a second dc-dc converter electrically coupled in series between the programmable power supply circuit and the battery, and the first dc-dc converter and the second dc-dc converter are configured to operate simultaneously.

In some embodiments, the power converter includes a charging circuit and a battery. The charging circuit is electrically coupled to the programmable power supply circuit, the programmable power supply circuit being configured to provide a regulated DC input voltage. The charging circuit includes a first dc-dc converter electrically coupled to the programmable power supply circuit and configured to convert the regulated DC input voltage to a system output voltage at an output node. The battery is electrically coupled to the first dc-dc converter, and configured to be charged or discharged, directly or indirectly via the output node. The charging circuit further includes a boost converter or a charge pump converter electrically coupled between the battery and the output node.

In some embodiments, the power converter includes a charging circuit and a battery. The charging circuit is electrically coupled to the programmable power supply circuit, the programmable power supply circuit being configured to provide a regulated DC voltage as a system output voltage at an output node. The charging circuit includes a first dc-dc converter electrically coupled to the programmable power supply circuit at the output node, and configured to perform a voltage conversion between the system output voltage and a battery voltage. The battery is electrically coupled to the first dc-dc converter, and configured to be charged or discharged, directly or indirectly, based on the battery voltage.

Embodiments of the present disclosure provide a method for charging and discharging a battery. In some embodiments, the method includes: during a first period, converting, by a first dc-dc converter electrically coupled to a programmable power supply circuit, a regulated DC input voltage to a system output voltage at an output node; during a charging period of the first period, charging a battery electrically coupled to the first dc-dc converter, directly or indirectly via the output node, based on the system output voltage; and during a second period, discharging the battery to provide the system output voltage, via the output node. The regulated DC input voltage is outputted by the programmable power supply circuit during the first period.

In some embodiments, the method includes: during a charging period of a first period, charging, by a first dc-dc converter electrically coupled to a programmable power supply circuit at an output node, a battery electrically coupled to the first dc-dc converter, directly or indirectly via the output node, based on a system output voltage by performing a voltage conversion between the system output voltage and a battery voltage of the battery; and during a second period, discharging the battery to provide the system output voltage, via the output node. The system output voltage is a regulated DC voltage outputted by the programmable power supply circuit at the output node during the first period.

Additional features and advantages of the disclosed embodiments will be set forth in part in the following description, and in part will be apparent from the description, or may be learned by practice of the embodiments. The features and advantages of the disclosed embodiments may be realized and attained by the elements and combinations set forth in the claims.

### BRIEF DESCRIPTION OF THE DRAWINGS

Embodiments and various aspects of the present disclosure are illustrated in the following detailed description and the accompanying figures. It is noted that, in accordance with standard practice in the industry, various features are not drawn to scale. In fact, the dimensions of the various features may be arbitrarily increased or reduced for clarity of discussion.

FIG. 1 is a block diagram of an exemplary power converter, in accordance with some embodiments of the present disclosure.

FIG. 2 is a block diagram of another exemplary power converter, in accordance with some embodiments of the present disclosure.

FIG. 3A is a block diagram of another exemplary power converter, in accordance with some embodiments of the present disclosure.

FIG. 3B illustrates the power flow during a discharging phase of the battery in the power converter of FIG. 3A, in accordance with some embodiments of the present disclosure.

FIG. 3C illustrates the power flow during a charging phase of the battery in the power converter of FIG. 3A, in accordance with some embodiments of the present disclosure.

FIG. 4 is a block diagram of another exemplary power converter, in accordance with some embodiments of the present disclosure.

FIG. 5 is a block diagram of another exemplary power converter, in accordance with some embodiments of the present disclosure.

FIG. 6 is a block diagram of another exemplary power converter, in accordance with some embodiments of the present disclosure.

FIG. 7A is a block diagram of another exemplary power converter, in accordance with some embodiments of the present disclosure.

FIG. 7B illustrates exemplary power flows during a discharging phase of the battery in the power converter of FIG. 7A, in accordance with some embodiments of the present disclosure.

FIG. 7C illustrates exemplary power flows during a charging phase of the battery in the power converter of FIG. 7A, in accordance with some embodiments of the present disclosure.

FIG. 8 is a block diagram of another exemplary power converter, in accordance with some embodiments of the present disclosure.

FIG. 9 is a flowchart of a method for charging and discharging a battery, in accordance with some embodiments of the present disclosure.

FIG. 10 is a flowchart of another method for charging and discharging a battery, in accordance with some embodiments of the present disclosure.

### DETAILED DESCRIPTION

The following disclosure provides many exemplary embodiments, or examples, for implementing different features of the provided subject matter. Specific simplified examples of components and arrangements are described below to explain the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In this document, the term “coupled” may also be termed as “electrically coupled”, and the term “connected” may be termed as “electrically connected”. “Coupled” and “connected” may also be used to indicate that two or more elements cooperate or interact with each other.

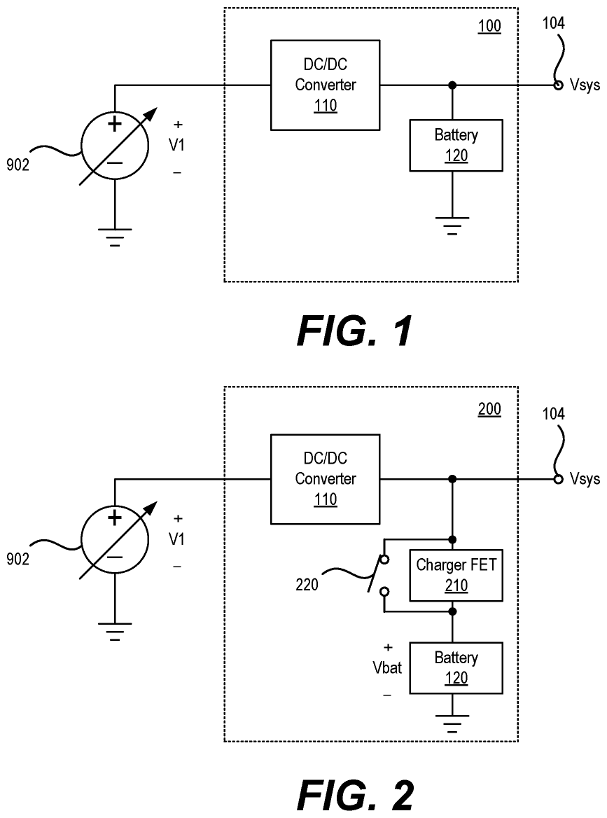

FIG. 1 is a block diagram of an exemplary power converter 100, in accordance with some embodiments of the present disclosure. As used herein, a power converter may refer to an apparatus containing power and electronic components of a power converting circuit. The power converter 100 of FIG. 1 includes a charging circuit including a dc-dc converter 110 and a battery 120 electrically coupled to the dc-dc converter 110. In some embodiments, the charging circuit of the power converter 100 further includes a converter 130 electrically coupled between the battery 120 and an output node 104 providing a system output voltage Vsys. Specifically, the charging circuit in FIG. 1 is electrically coupled to a programmable power supply circuit 902. The programmable power supply circuit 902 can be an Adjustable Voltage Source (AVS) and configured to provide a regulated DC input voltage V1. The voltage level of the regulated DC input voltage V1 can be dynamically adjusted by the programmable power supply circuit 902, in response to corresponding commands. In some embodiments, the regulated DC input voltage V1 may be a supply voltage from an AC-DC adaptor connected to the power converter 100. The dc-dc converter 110 is electrically coupled to the programmable power supply circuit 902 and configured to convert the regulated DC input voltage V1 to the system output voltage Vsys at the output node 104 of the power converter 100. The battery 120 is configured to be charged or discharged, directly or indirectly via the output node 104. As shown in the embodiments of FIG. 1, the battery 120 can be charged by the power outputted by the dc-dc converter 110 directly. In some embodiments, the converter 130 may be a boost converter or a charge pump converter providing a fixed offset between the battery voltage of the battery 120 and the system output voltage Vsys.

In some embodiments, the dc-dc converter 110 may be a buck converter, a boost converter, or a charge pump converter, etc., but the present disclosure is not limited thereto. As used in this disclosure, the term “charge pump” refers to a switched-capacitor network configured to convert an input voltage (e.g., the regulated DC input voltage V1 in FIG. 1) to an output voltage (e.g., the system output voltage Vsys in FIG. 1). Examples of such charge pumps include cascade multiplier, Dickson, ladder, series-parallel, Fibonacci, and Doubler switched-capacitor networks, all of which may be configured as a multi-phase or a single-phase network. In addition, in the context of the present disclosure, power converting circuits that convert a higher input voltage power source to a lower output voltage level are commonly known as step-down or buck converters, because the converter is “bucking” the input voltage. Power converting circuits that convert a lower input voltage power source to a higher output voltage level are commonly known as step-up or boost converters, because the converter is “boosting” the input voltage. In addition, some power converters, commonly known as “buck-boost converters,” may be configured to convert the input voltage power source to the output voltage with a wide range, in which the output voltage may be either higher than or lower than the input voltage. In various embodiments, a power converter may be bidirectional, being either a step-up or a step-down converter depending on how a power source is connected to the converter.

Accordingly, the power converter 100 in FIG. 1 provides a charging mechanism, in which a single dc-dc converter 110 is configured to convert the regulated DC input voltage V1 to the system output voltage Vsys, and the system output voltage Vsys can be used to charge the battery 120 directly and to provide the system voltage required by the circuits or devices in a next power stage connecting to the output node 104. When the programmable power supply circuit 902 is the power source, the power converter 100 receives the regulated DC input voltage V1 from the programmable power supply circuit 902 as the input voltage, with a proper voltage level controlled and regulated by the programmable power supply circuit 902. When the battery 120 is the power source, the converter 130 may be configured to provide the system output voltage Vsys accordingly. Thus, the voltage range of the system output voltage Vsys can be narrower and within a desired voltage range. For example, in some embodiments, the system output voltage Vsys may be in the range of about 9V-5V for a 2S cell (i.e., 2 battery cells connected in series) application in a Narrow Voltage DC (NVDC) Architecture. In addition, the architecture shown in FIG. 1 also provides more flexibility for the regulation of the input voltage of the dc-dc converter 110 to maximize the power efficiency. Because the system output voltage Vsys may be indirectly controlled and regulated according to the regulated DC input voltage V1, the dc-dc converter 110 may be an unregulated converter with a high efficiency. Accordingly, the switching loss of the power converter 100 can be reduced, and the overall efficiency of the power converter 100 can be improved.

FIG. 2 is a block diagram of another exemplary power converter 200, in accordance with some embodiments of the present disclosure. Compared to the power converter 100 of FIG. 1, the power converter 200 further includes a charger transistor 210 and a switch device 220 electrically coupled in parallel to the charger transistor 210. As shown in FIG. 2, the charger transistor 210 is electrically coupled in series between the dc-dc converter 110 and the battery 120 via the output node 104. The charger transistor 210 is configured to enable or disable charging or discharging of the battery 120. For example, when the battery 120 is fully charged, the charger transistor 210 can be controlled in response to a corresponding control command from a controller IC (not shown) to disable the charging of the battery 120 by disconnecting the battery 120 from the dc-dc converter 110. On the other hand, when the battery 120 needs to be charged, the charger transistor 210 can be controlled in response to a corresponding control command from the controller IC to enable the charging of the battery 120 based on the system output voltage Vsys outputted from the dc-dc converter 110.

Similarly, when the power converter 200 receives the regulated DC input voltage V1 and performs the power conversion to provide the system output voltage Vsys based on the regulated DC input voltage V1, the charger transistor 210 can be controlled in response to a corresponding control command from the controller IC to disable the discharging of the battery 120 by disconnecting the battery 120 from the output node 104. On the other hand, when the battery needs to output the system output voltage Vsys for the next stage, the charger transistor 210 can be controlled in response to a corresponding control command from the controller IC to discharge the battery 120 at the desired power level.

The power converter 200 in FIG. 2 can achieve a novel charging mechanism by using an adjustable voltage source (e.g., the regulated DC input voltage V1 from the programmable power supply circuit 902) to replace a fixed voltage source to provide the system output voltage Vsys and the provide power to charge the battery 120.

In some embodiments, the switch device 220 is an optional switching element. The switch device 220 in parallel to the charger transistor 210 is configured to bypass the charger transistor 210 when the switch device 220 is closed. Specifically, the switch device 220 can be controlled and used to bypass the charger transistor 210 in response to the power mode when applicable and provide a less resistive power path between the battery 120 and the output node 104. Accordingly, the overall power efficiency can be improved. For example, when the programmable power supply circuit 902 is used at the power source, the power converter 200 may receive the regulated DC input voltage V1 to provide a high efficient system output voltage Vsys. During a Constant Current (CC) mode, the switch device 220 may be enabled to bypass the charger transistor 210. In addition, when the battery 120 is used at the power source, the switch device 220 may also be enabled to bypass the charger transistor 210, so that the battery 120 can provide the system output voltage Vsys directly to the output node 104 of the power converter 200.

In some embodiments, the charging circuit of the power converter 200 may include additional components. The circuit shown FIG. 2 is an example and not meant to limit the present disclosure. For example, similar to the embodiments of FIG. 1, the charging circuit of the power converter 200 may further include another boost converter or charge pump converter providing a fixed offset between the battery voltage Vbat of the battery 120 and the system output voltage Vsys to ensure that the system output voltage Vsys does not reach or exceed the battery voltage Vbat. In some embodiments, the charging path including the charger transistor 210 can thus be removed accordingly.

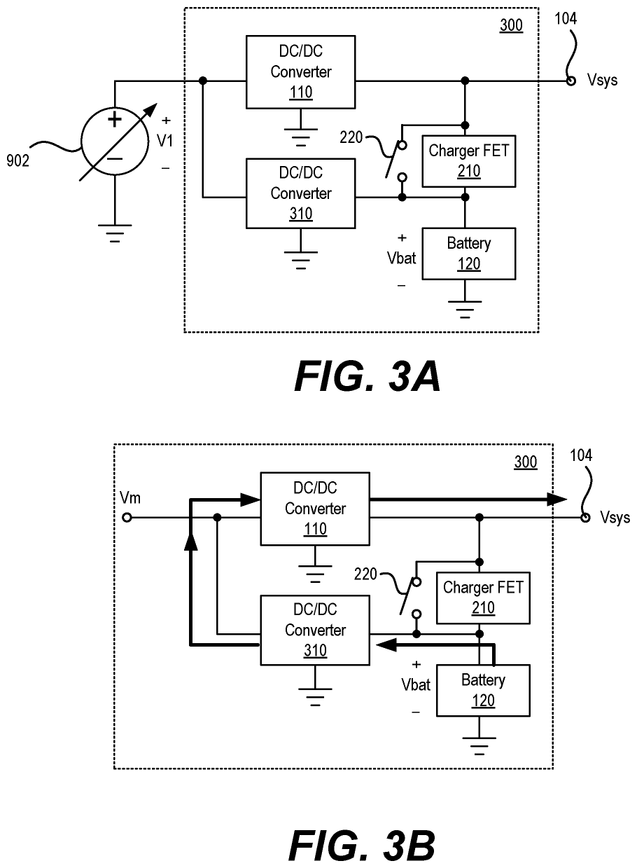

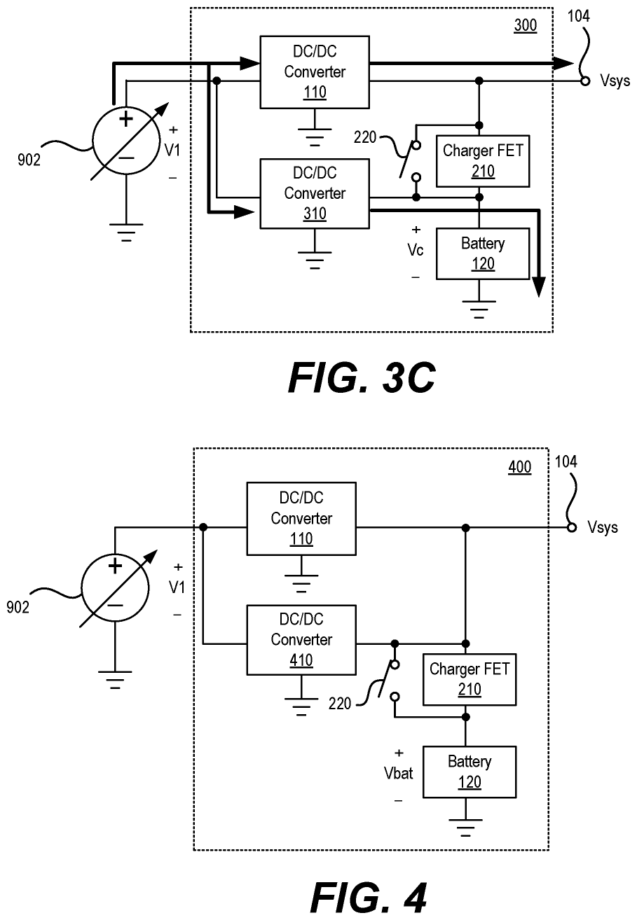

FIG. 3A is a block diagram of another exemplary power converter 300, in accordance with some embodiments of the present disclosure. Compared to the power converter 200 of FIG. 2, the power converter 300 further includes another dc-dc converter 310. As shown in FIG. 3A, the dc-dc converter 310 is electrically coupled in series between the programmable power supply circuit 902 and the battery 120. The charger transistor 210 is electrically coupled between the dc-dc converter 110 and the dc-dc converter 310. In some embodiments, the dc-dc converter 110 and the dc-dc converter 310 are configured to operate simultaneously.

For example, FIG. 3B illustrates the power flow during a discharging phase of the battery 120 in the power converter 300 of FIG. 3A, in accordance with some embodiments of the present disclosure. As shown in FIG. 3B, in the discharging phase of the battery 120, the dc-dc converter 310 may be configured to convert the battery voltage Vbat outputted by the battery 120 to a first voltage (e.g., the voltage Vm) received by the dc-dc converter 110. The dc-dc converter 110 is configured to regulate and provide the system output voltage Vsys, in response to the first voltage (e.g., the voltage Vm) from the dc-dc converter 310.

For example, FIG. 3C illustrates the power flow during a charging phase of the battery 120 in the power converter 300 of FIG. 3A, in accordance with some embodiments of the present disclosure. As shown in FIG. 3C, in the charging phase of the battery 120, the dc-dc converter 110 is configured to provide the system output voltage Vsys, in response to the regulated DC input voltage V1 from the programmable power supply circuit 902. The dc-dc converter 310 is configured to provide a charging voltage Vc to the battery 120, in response to the regulated DC input voltage V1 from the programmable power supply circuit 902.

In various embodiments, different converter types can be applied to implement a high-efficient converter for the dc-dc converter 310. For example, the dc-dc converter 310 may be a magnetic-based unregulated converter, an LLC converter, a switched-capacitor (SC)-based converter, etc. In some embodiments, one of the dc-dc converter 110 and the dc-dc converter 310 can be an unregulated converter, and the other one of the dc-dc converter 110 and the dc-dc converter 310 can be a regulated converter. During the discharging phase of the battery 120, the system output voltage Vsys can be regulated by the regulated converter. During the charging phase of the battery 120, the system output voltage Vsys and the charging voltage Vc can be regulated by the regulated converter and the programmable power supply circuit 902 providing the regulated DC input voltage V1.

For example, if the dc-dc converter 110 is an unregulated converter, then during the discharging phase of the battery 120 shown in FIG. 3B, the system output voltage Vsys can be indirectly controlled and regulated by the dc-dc converter 310 providing a regulated voltage Vm. During the charging phase of the battery 120 shown in FIG. 3C, the system output voltage Vsys can be indirectly controlled and regulated by the programmable power supply circuit 902 providing the regulated DC input voltage V1, and the charging voltage Vc can be regulated by the dc-dc converter 310.

In another example, if the dc-dc converter 310 is an unregulated converter, then during the discharging phase of the battery 120 shown in FIG. 3B, the system output voltage Vsys can be controlled and regulated by the dc-dc converter 110 outputting the system output voltage Vsys. During the charging phase of the battery 120 shown in FIG. 3C, the charging voltage Vc can be indirectly controlled and regulated by the programmable power supply circuit 902 providing the regulated DC input voltage V1, and the system output voltage Vsys can be regulated by the dc-dc converter 110. The embodiments of FIGS. 3A-3C can achieve a flash charging mechanism by using one regulating converter and one high efficiency unregulated converter to provide the system output voltage Vsys at a high voltage (HV) level and provide the charging voltage Vc at a desired level for the battery 120. By running the dc-dc converter 110 and the dc-dc converter 310 simultaneously, the overall power efficiency can be improved. In some embodiments, different charging/discharging modes can be achieved by selecting the converters to be enabled or disabled.

FIG. 4 is a block diagram of another exemplary power converter 400, in accordance with some embodiments of the present disclosure. Compared to the power converter 300 of FIGS. 3A-3C, the power converter 400 also includes another dc-dc converter 410, and the dc-dc converter 110 and the dc-dc converter 410 are electrically coupled in parallel.

In some embodiments, the dc-dc converter 410 and the dc-dc converter 110 operate at the same conversion ratio. In some embodiments, one of the dc-dc converter 410 and the dc-dc converter 110 may be unregulated. By arranging the dc-dc converter 410 and the dc-dc converter 110 in parallel, the power path providing the system output voltage Vsys or the charging voltage to the battery 120 can be optimized with the dc-dc converter 410 and the dc-dc converter 110 operating together to provide additional power.

Similar to the power converter 300, in some embodiments, the switch device 220 is electrically coupled in parallel to the charger transistor 210. In a charging phase of the battery 120, the switch device 220 is closed to bypass the charger transistor 210 to achieve a high efficiency charging to the battery 120. In a discharging phase of the battery 120, the switch device 220 is closed to bypass the charger transistor 210 to provide the system output voltage Vsys from the battery 120. Thus, when the power is drawn from the battery 120, the system output voltage Vsys may be the battery voltage Vbat, instead of a reduced voltage due to the voltage drop across the charger transistor 210.

In some other embodiments, the charging circuit of the power converter 300 or 400 may include additional components. The charging circuits shown in FIGS. 3A-3C and FIG. 4 are examples and not meant to limit the present disclosure. For example, similar to the embodiments of FIG. 1, the charging circuit of the power converter 300 or 400 may further include another boost converter or charge pump converter providing a fixed offset between the battery voltage Vbat of the battery 120 and the system output voltage Vsys to ensure that the system output voltage Vsys does not reach or exceed the battery voltage Vbat, and is at a specific level (e.g., 5V). In some embodiments, the charging path including the charger transistor 210 can thus be removed accordingly.

In the above embodiments of FIG. 1 to FIG. 4, the programmable power supply circuit 902 can be used as an adjustable and dynamic input voltage source to replace the fixed input voltage source in the traditional design. The programmable power supply circuit 902 can be applied to maximize the power efficiency by regulating the input voltage of the dc-dc converter(s) (e.g., dc-dc converters 110, 310, and 410) in the power converters. In some embodiments, the battery 120 can be connected to a boost converter or a charge pump converter for outputting a regulated system output voltage Vsys. Accordingly, the voltage range of the system output voltage Vsys can be narrower. In some embodiments, a fixed offset between the battery voltage Vbat of the battery 120 and the system output voltage Vsys can be ensured.

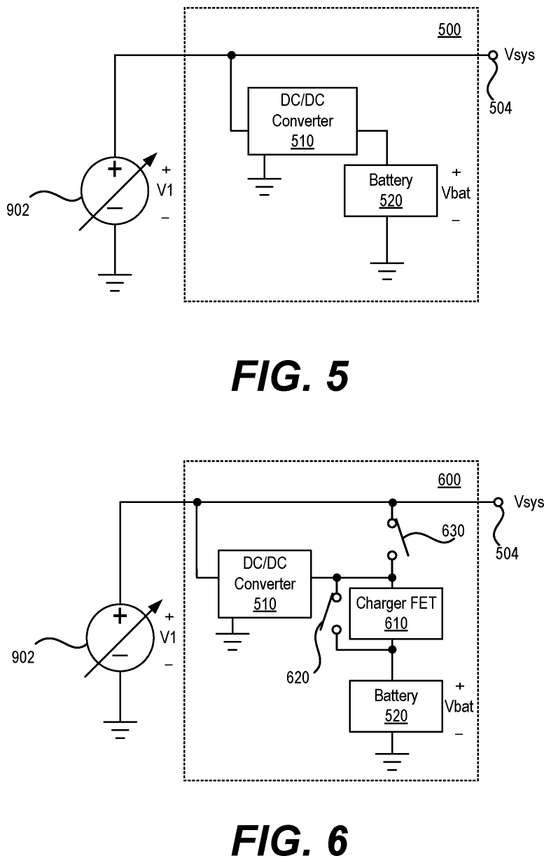

FIG. 5 is a block diagram of another exemplary power converter 500, in accordance with some embodiments of the present disclosure. Compared to the above embodiments of FIG. 1 to FIG. 4, the power converter 500 is designed for a Wide Voltage DC (WVDC) architecture. The power converter 500 may be configured to provide the system output voltage Vsys with a wider voltage range compared to NVDC architectures in the above embodiments of FIG. 1 to FIG. 4. In some embodiments, in the WVDC architecture, the system output voltage Vsys may be in the voltage range of about 20V-5V, which is broader than the voltage range of about 9V-5V for an exemplary NVDC architecture, but the present disclosure is not limited thereto.

As shown in FIG. 5, the power converter 500 includes a charging circuit including a dc-dc converter 510 and a battery 520 electrically coupled to the dc-dc converter 510. Specifically, the charging circuit in FIG. 5 is electrically coupled to a programmable power supply circuit 902. Similar to the embodiments above, the programmable power supply circuit 902 can be an Adjustable Voltage Source (AVS). The programmable power supply circuit 902 is configured to provide the regulated DC voltage V1 as a system output voltage Vsys at an output node 504 of the power converter 500 to the next stage.

The dc-dc converter 510 is electrically coupled to the programmable power supply circuit 902 at the output node 504 and is configured to perform a voltage conversion between the system output voltage Vsys and a battery voltage Vbat of the battery 520. The battery 520 is electrically coupled to the dc-dc converter 510 and configured to be charged or discharged, directly or indirectly, based on the battery voltage Vbat.

The power converter 500 provides a charging mechanism without arranging a charger transistor in the charging circuit of the power converter 500. In some embodiments, the dc-dc converter 510 may be a Low-dropout regulator (LDO).

FIG. 6 is a block diagram of another exemplary power converter 600, in accordance with some embodiments of the present disclosure. The power converter 600 may also be designed for the WVDC architecture. Compared to the power converter 500 of FIG. 5, the power converter 600 further includes a charger transistor 610 and switch devices 620 and 630 electrically coupled to the charger transistor 610.

As shown in FIG. 6, the charger transistor 610 is electrically coupled in series between the dc-dc converter 510 and the battery 520 and configured to enable or disable charging or discharging of the battery 520. The switch device 620 is electrically coupled in parallel to the charger transistor 610 and configured to bypass the charger transistor 610 when the switch device 620 is closed. The switch device 630 is electrically coupled in parallel to the dc-dc converter 510 and configured to enable a direct charging or discharging between the battery 520 and the output node 504 of the power converter 600 when the switch device 630 is closed. In some embodiments, one or more of the charger transistor 610 and switch devices 620 and 630 may be optional.

In particular, the charger transistor 610 electrically coupled between the dc-dc converter 510 and the battery 520 can minimize voltage and current ripples of the battery voltage Vbat across the battery 520. Similar to the embodiments above, the charger transistor 610 and the switch device 620 may be configured to enable or disable charging or discharging of the battery 520. Detailed operations of the charger transistor 610 and the switch device 620 are similar to those of the charger transistor 210 and the switch device 220, and thus are not repeated herein for the sake of brevity.

In some embodiments, the switch device 620 and the switch device 630 can be used to achieve the direct charging of the battery 520. For example, when the battery 520 is charged using the system output voltage Vsys (or the regulated DC voltage V1 from the programmable power supply circuit 902) directly under a direct charging mode, the switch device 620 and the switch device 630 can be closed, in response to a corresponding control command from a controller IC (not shown), to provide a less resistive power path between the battery 520 and the output node 504. Accordingly, the overall power efficiency can be improved.

On the other hand, when a voltage conversion between the system output voltage Vsys and the battery voltage Vbat of the battery 520 is needed, the switch device 630 can be opened, and the battery 520 is charged by the voltage outputted by the dc-dc converter 510. In other words, the charger transistor 610, the switch device 620, and the switch device 630 can be respectively controlled to operate the power converter 600 under various power modes according to various system conditions and desired outcomes to supply the system output voltage Vsys to the load, and to charge or discharge the battery 520 efficiently without causing damages (e.g., over-charge or over-voltage) to the battery 520. In some embodiments, the power converter 600 can dynamically switch between different power modes by detecting the system conditions to optimize its operation automatically.

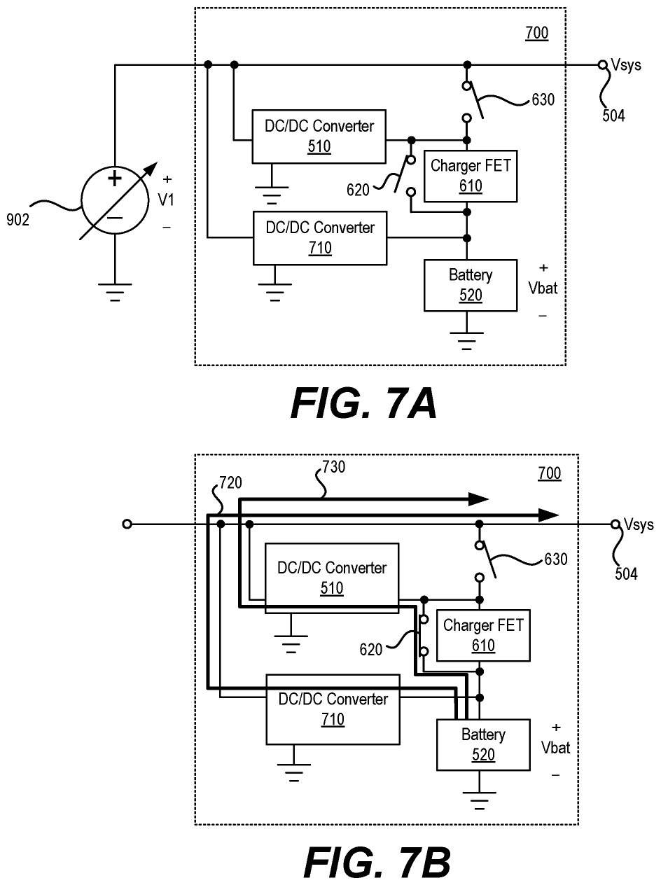

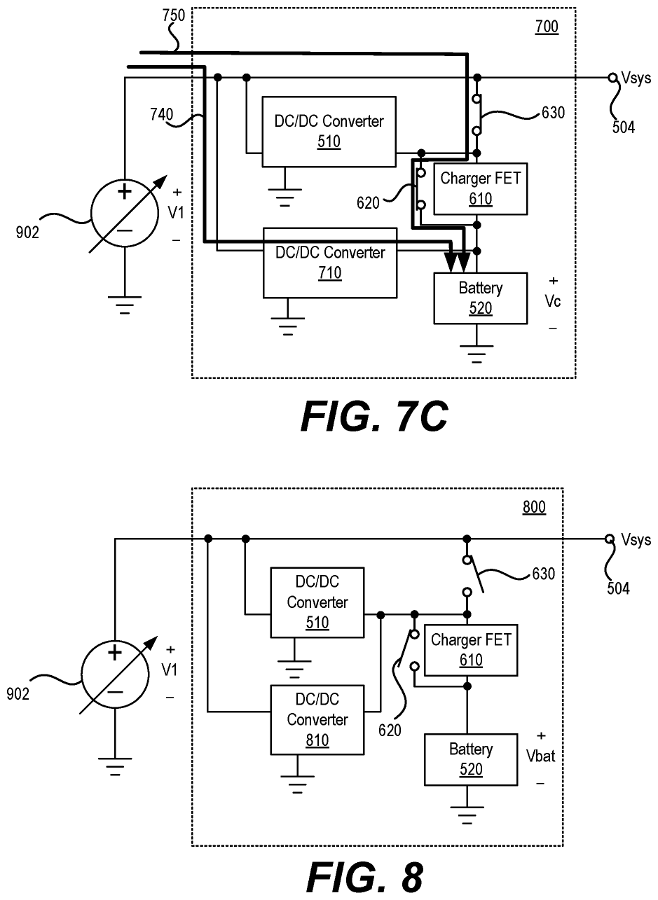

FIG. 7A is a block diagram of another exemplary power converter 700, in accordance with some embodiments of the present disclosure. Compared to the power converter 600 of FIG. 6, the power converter 700 further includes another dc-dc converter 710. In some embodiments, one of the dc-dc converter 510 and the dc-dc converter 710 may be an unregulated converter, which may be a high-efficiency converter, and the other one of the dc-dc converter 510 and the dc-dc converter 710 may be a regulated converter. As shown in FIG. 7A, the dc-dc converter 710 is electrically coupled in series between the programmable power supply circuit 902 and the battery 520. The charger transistor 610 is electrically coupled between the dc-dc converter 510 and the dc-dc converter 710. In some embodiments, the dc-dc converter 510 and the dc-dc converter 710 are configured to operate simultaneously under certain power modes, but the present disclosure is not limited thereto.

FIG. 7B illustrates exemplary power flows during a discharging phase of the battery 520 in the power converter 700 of FIG. 7A, in accordance with some embodiments of the present disclosure. A power path 720 in FIG. 7B indicates an exemplary power flow during a discharging phase of the battery 520. In the power path 720, during the discharging phase of the battery 520, the dc-dc converter 710 is configured to convert the battery voltage Vbat outputted by the battery 520 to the desired system output voltage Vsys. As shown in FIG. 7B, in some embodiments, the switch device 620 can be closed, in response to a corresponding control command from a controller IC, to provide another power path 730 during the discharging phase of the battery 520, in which the dc-dc converter 510 is configured to convert the battery voltage Vbat outputted by the battery 520 to the desired system output voltage Vsys. Accordingly, the power converter 700 can supply greater output power in response to the system's request, with relative low power-rating dc-dc converters 510 and 710. When the required output power is relatively low, the power converter 700 may also enable one of the dc-dc converters 510 and 710 to reduce the power loss and thus improve the overall power efficiency.

FIG. 7C illustrates exemplary power flows during a charging phase of the battery 520 in the power converter 700 of FIG. 7A, in accordance with some embodiments of the present disclosure. A power path 740 in FIG. 7C indicates an exemplary power flow during a charging phase of the battery 520. In the power path 740, during the charging phase of the battery 520, the dc-dc converter 710 is configured to convert the system output voltage Vsys (or the regulated DC voltage V1 from the programmable power supply circuit 902) to a desired charging voltage Vc to the battery 520, in the condition that the system output voltage Vsys is not within a desired voltage range for charging the battery 520. On the other hand, when the programmable power supply circuit 902 is able to provide the regulated DC voltage V1 at an optimized voltage level as the charging voltage Vc to charge the battery 520 directly, the switch devices 620 and 630 can be closed to provide a power path 750 to enable to a direct charging to improve the efficiency.

It is appreciated that power paths 720-750 shown in FIG. 7B and FIG. 7C are merely examples and not meant to limit the present disclosure. In various embodiments, the power converter 700 can control the dc-dc converters 510 and 710, the charger transistor 610, and the switch devices 620 and 630 accordingly to operate at a desired charging or discharging mode to charge or discharge the battery 520 and output the system output voltage Vsys according to the system's needs using the programmable power supply circuit 902 or the battery 520 as the power source.

FIG. 8 is a block diagram of another exemplary power converter 800, in accordance with some embodiments of the present disclosure. Compared to the power converter 700 of FIGS. 7A-7C, the power converter 800 also includes another dc-dc converter 810. Similar to the embodiments of FIGS. 7A-7C, one of the dc-dc converter 510 and the dc-dc converter 810 may be an unregulated converter, and the other one of the dc-dc converter 510 and the dc-dc converter 810 may be a regulated converter.

As shown in FIG. 8, the dc-dc converters 510 and 810 are electrically coupled in parallel. In some embodiments, the dc-dc converter 510 and the dc-dc converter 810 operate at the same conversion ratio. By arranging the dc-dc converter 510 and the dc-dc converter 810 in parallel, the power path providing the system output voltage Vsys or the charging voltage to the battery 520 can be optimized with the dc-dc converter 510 and the dc-dc converter 810 operating together to provide additional power. Thus, similar to the power converter 700 of FIGS. 7A-7C, the power converter 800 can also supply greater output power in response to the system's request, with relatively low power-rating dc-dc converters 510 and 810 to achieve a flash charging. When the required output power is relatively low, the power converter 800 may also enable one of the dc-dc converters 510 and 810 to reduce the power loss and thus improve the overall power efficiency.

Similar to the power converter 700, in some embodiments, the switch device 620 is electrically coupled in parallel to the charger transistor 610. In the charging phase of the battery 520, the switch device 620 can be closed to bypass the charger transistor 610 to achieve high-efficiency charging to the battery 520. In the discharging phase of the battery 520, the switch device 620 may be closed to bypass the charger transistor 610 to provide the system output voltage Vsys from the battery 520 directly. Thus, when the power is drawn from the battery 520, the system output voltage Vsys may be the battery voltage Vbat, instead of a reduced voltage due to the voltage drop across the charger transistor 610.

In some embodiments, one or both of the dc-dc converters 510 and 810 may be a boost converter or a charge pump converter to provide a fixed offset between the battery voltage Vbat of the battery 520 and the system output voltage Vsys to ensure that the system output voltage Vsys is at a specific level, when one or both of the switch devices 620 and 630 are opened and the power flows through one or both of the dc-dc converters 510 and 810. In some other embodiments, the charging circuit of the power converter 700 or 800 may include additional components. The charging circuits shown herein are examples and not meant to limit the present disclosure.

In the above embodiments of FIG. 5 to FIG. 8, the programmable power supply circuit 902 can be used as an adjustable and dynamic input voltage source in various wide voltage DC architectures to replace the fixed input voltage source in the traditional design. The programmable power supply circuit 902 can be applied to maximize the power efficiency by regulating the input voltage of the dc-dc converter(s) (e.g., dc-dc converters 510, 710, and 810) in the power converters. In some embodiments, the battery 520 can be connected to a boost converter or a charge pump converter for outputting a regulated system output voltage Vsys. Accordingly, the voltage range of the system output voltage Vsys can be narrower. In some embodiments, a fixed offset between the battery voltage Vbat of the battery 520 and the system output voltage Vsys can be ensured.

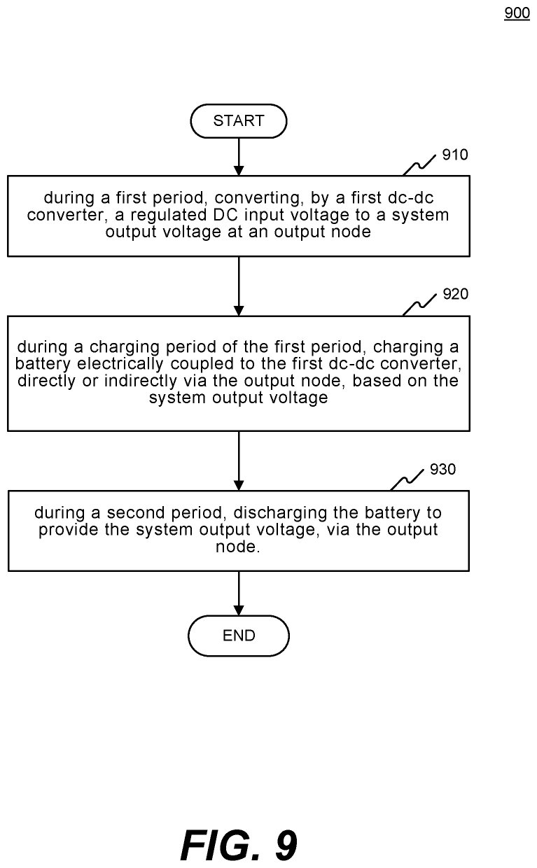

FIG. 9 is a flowchart of a method 900 for charging and discharging a battery, in accordance with some embodiments of the present disclosure. It is understood that additional operations may be performed before, during, and/or after the method 900 depicted in FIG. 9, and that some other processes may only be briefly described herein. The method 900 can be performed by a power converter, e.g., any of the power converters 100, 200, 300 or 400 illustrated in the embodiments of FIG. 1-FIG. 4 above, but the present disclosure is not limited thereto.

As shown in FIG. 9. The method 900 includes operations 910, 920 and 930. In operation 910, during a first period, a programmable power supply circuit (e.g., programmable power supply circuit 902 in FIG. 1) is electrically coupled to the power converter and used as a power source. The power converter is configured to convert, by a first dc-dc converter (e.g., dc-dc converter 110 in FIG. 1) electrically coupled to the programmable power supply circuit, a regulated DC input voltage (e.g., regulated DC input voltage V1 in FIG. 1) outputted by the programmable power supply circuit during the first period to a system output voltage (e.g., system output voltage Vsys in FIG. 1) at an output node (e.g., output node 104 in FIG. 1). In some embodiments, the first dc-dc converter may be a boost converter or a charge pump converter.

In operation 920, during a charging period of the first period, the power converter is configured to charge a battery (e.g., battery 120 in FIG. 1) electrically coupled to the first dc-dc converter, directly or indirectly via the output node, based on the system output voltage.

In operation 930, during a second period, the battery is used as a power source, and the power converter is configured to discharge the battery to provide the system output voltage, via the output node.

In some embodiments, in the operation 920 during the charging period or the operation 930 during the second period, the power converter may be configured to enable or disable charging or discharging of the battery via a charger transistor (e.g., charger transistor 210 in FIG. 2) electrically coupled in series between the first dc-dc converter and the battery via the output node. In addition, in some embodiments, in the operation 920 or 930, the power converter may be configured to, during the charging period or the second period, close a switch device electrically coupled in parallel to the charger transistor to bypass the charger transistor. Accordingly, the power converter may provide a less resistive power path to improve the overall power efficiency.

In some embodiments, the method 900 may further include operating multiple dc-dc converters electrically coupled to each other. For example, the power converter may be configured to operate the first dc-dc converter and a second dc-dc converter (e.g., dc-dc converter 310 or 410 in FIGS. 3A-3C or FIG. 4) electrically coupled in series between the programmable power supply circuit and the battery simultaneously to provide the system output voltage at the output node. One of the first dc-dc converter and the second dc-dc converter may be an unregulated converter. In some embodiments, the charger transistor may be electrically coupled between the first dc-dc converter and the second dc-dc converter. In some other embodiments, the first dc-dc converter and the second dc-dc converter may be electrically coupled in parallel.

For example, as previously discussed in FIG. 3B, operations of operating the first dc-dc converter and the second dc-dc converter may include during the second period, converting, by the second dc-dc converter, a battery voltage (e.g., battery voltage Vbat in FIG. 3B) outputted by the battery to a first voltage (e.g., voltage Vm in FIG. 3B) and regulating the first voltage, by the first dc-dc converter, to provide the system output voltage.

In some embodiments, as previously discussed in FIG. 3C, operations of operating the first dc-dc converter and the second dc-dc converter may include during the charging period, regulating and providing the system output voltage, by the first dc-dc converter, in response to the regulated DC input voltage from the programmable power supply circuit, and providing a charging voltage (e.g., charging voltage Vc in FIG. 3C) to the battery, by the second dc-dc converter, in response to the regulated DC input voltage from the programmable power supply circuit.

In addition, as previously discussed in FIGS. 2-4, the method 900 for charging and discharging the battery may further include during the charging period, closing a switch device (e.g., switch device 220 in FIGS. 2-4) electrically coupled in parallel to the charger transistor to bypass the charger transistor, and/or during the second period, closing the switch device to bypass the charger transistor to provide the system output voltage from the battery. Accordingly, the power converter may provide a less resistive power path to improve the overall power efficiency.

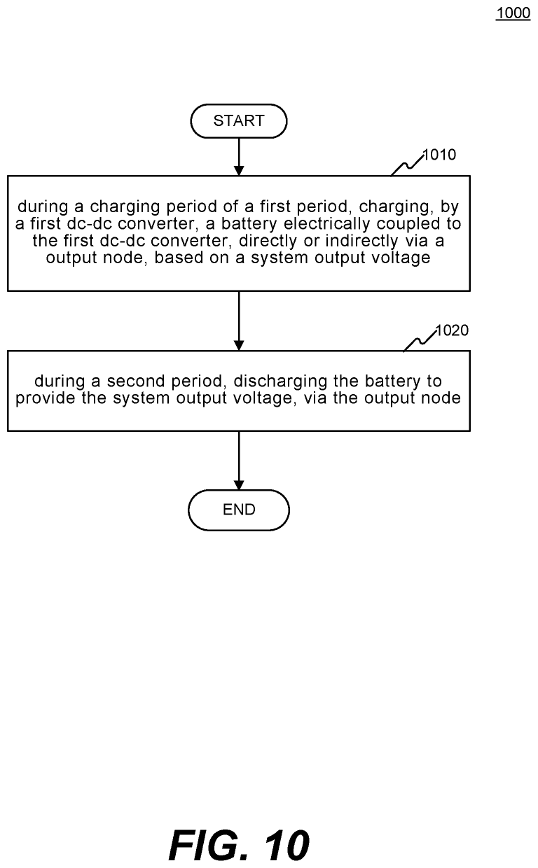

FIG. 10 is a flowchart of another method 1000 for charging and discharging a battery, in accordance with some embodiments of the present disclosure. It is understood that additional operations may be performed before, during, and/or after the method 1000 depicted in FIG. 10, and that some other processes may only be briefly described herein. The method 1000 can be performed by a power converter, e.g., any of the power converters 500, 600, 700 or 800 illustrated in the embodiments of FIG. 5-FIG. 8 above, but the present disclosure is not limited thereto.

As shown in FIG. 10. The method 1000 includes operations 1010 and 1020. In operation 1010, during a first period, a programmable power supply circuit (e.g., programmable power supply circuit 902 in FIG. 5) is electrically coupled to the power converter and used as a power source. During a charging period of the first period, the power converter is configured to charge, by a first dc-dc converter (e.g., dc-dc converter 510 in FIG. 5), a battery (e.g., battery 520 in FIG. 5) electrically coupled to the first dc-dc converter, directly or indirectly. In particular, the first dc-dc converter is electrically coupled to the programmable power supply circuit at an output node (e.g., output node 504 in FIG. 5), and the power converter is configured to charge the battery via the output node, based on a system output voltage (e.g., system output voltage Vsys in FIG. 5) by performing a voltage conversion between the system output voltage and a battery voltage (e.g., battery voltage Vbat in FIG. 5) of the battery. The system output voltage is a regulated DC voltage outputted by the programmable power supply circuit at the output node during the first period.

In operation 1020, during a second period, the battery is used as a power source, and the power converter is configured to discharge the battery to provide the system output voltage, via the output node.

As previously discussed in FIG. 6, in operations 1010 and 1020, the method 1000 may further include enabling or disabling charging or discharging of the battery via a charger transistor (e.g., charger transistor 610 in FIGS. 6-8) electrically coupled in series between the first dc-dc converter and the battery via the output node. In addition, the power converter may be configured to, during the charging period or the second period, close a first switch device (e.g., switch device 620 in FIGS. 6-8) electrically coupled in parallel to the charger transistor to bypass the charger transistor. The power converter may also be configured to, during the charging period or the second period, closing a second switch device (e.g., switch device 630 in FIGS. 6-8) electrically coupled in parallel to the first dc-dc converter to enable a direct charging or discharging between the battery and the output node.

As previously discussed in FIGS. 7A-7C and 8, the method 1000 may further include operating the first dc-dc converter and a second dc-dc converter (e.g., dc-dc converter 710 or 810 in FIGS. 7A-7C and 8) electrically coupled between the programmable power supply circuit and the charger transistor. In some embodiments, one of the first dc-dc converter and the second dc-dc converter is an unregulated converter, and the other one of the first dc-dc converter and the second dc-dc converter is a regulated converter. As previously discussed in FIGS. 7A-7C, the charger transistor may be electrically coupled between the first dc-dc converter and the second dc-dc converter. As previously discussed in FIG. 8, the first dc-dc converter and the second dc-dc converter may be electrically coupled in parallel. By using multiple dc-dc converters, the power converter can supply greater output power in response to the system's request, with relative low power-rating dc-dc converters, and operate under different charging or discharging modes according to the different scenarios and system conditions by controlling the dc-dc converters respectively. Details of the operations have been discussed above and thus are not repeated herein for the sake of brevity.

In summary, various battery charging/discharging topologies are provided to realize a highly efficient power supply system and offer improved charging capability to the battery and/or increased design flexibility compared to the existing solutions. The proposed power converters can be configured to charge a battery within the converter device and provide a system voltage for various mobile applications with different voltage requirements and achieve multi-mode battery charging in response to various scenarios and system conditions.

In some embodiments, the power converter may dynamically switch between charging/discharging modes in response to various conditions and desired outcomes. The mode selection may be based on commands from a user to provide a personalized power management strategy for the user, and may also be based on commands from a controller to achieve an optimized power management. Examples of the charging/discharging modes may include a high-power charging mode which requires less charging time to complete the charging process, a high-efficiency charging mode which causes less damages to the battery and extends the battery life and the performance of the battery, etc.

In the foregoing specification, embodiments have been described with reference to numerous specific details that can vary from implementation to implementation. Certain adaptations and modifications of the described embodiments can be made. It is also intended that the sequence of steps shown in figures is only for illustrative purposes and is not intended to be limited to any particular sequence of steps. As such, those skilled in the art can appreciate that these steps may be performed in a different order while implementing the same method.

The various example embodiments herein may be described in the general context of method steps or processes, which may be implemented in one aspect by a computer program product, embodied in a transitory or a non-transitory computer-readable medium. For example, a non-transitory computer-readable storage medium may store a set of instructions that are executable by one or more processors of a device to cause the device to perform a method for designing a frame structure for stacking circuit assemblies. A computer-readable medium may include removable and nonremovable storage devices including, but not limited to, Read Only Memory (ROM), Random Access Memory (RAM), compact discs (CDs), digital versatile discs (DVD), etc.

It is appreciated that certain features of the specification, which are, for clarity, described in the context of separate embodiments, may also be provided in combination in a single embodiment. Conversely, various features of the specification, which are, for brevity, described in the context of a single embodiment, may also be provided separately or in any suitable sub-combination or as suitable in any other described embodiment of the specification. Certain features described in the context of various embodiments are not to be considered essential features of those embodiments unless the embodiment is inoperative without those elements.

The embodiments may further be described using the following clauses:

1. A power converter for use with a programmable power supply circuit, comprising:
a charging circuit electrically coupled to the programmable power supply circuit, the programmable power supply circuit being configured to provide a regulated DC input voltage, the charging circuit comprising: a first dc-dc converter electrically coupled to the programmable power supply circuit and configured to convert the regulated DC input voltage to a system output voltage at an output node; and
a battery electrically coupled to the first dc-dc converter, and configured to be charged or discharged, directly or indirectly via the output node,
wherein the charging circuit further comprises a charger transistor electrically coupled in series between the first dc-dc converter and the battery via the output node and configured to enable or disable charging or discharging of the battery.

2. The power converter of clause 1, further comprising:
a boost converter or a charge pump converter coupled between the battery and the output node.

3. The power converter of clause 1 or clause 2, further comprising:
a switch device electrically coupled in parallel to the charger transistor and configured to bypass the charger transistor when the switch device is closed.

4. A power converter for use with a programmable power supply circuit, comprising:
a charging circuit electrically coupled to the programmable power supply circuit, the programmable power supply circuit being configured to provide a regulated DC input voltage, the charging circuit comprising: a first dc-dc converter electrically coupled to the programmable power supply circuit and configured to convert the regulated DC input voltage to a system output voltage at an output node; and
a battery electrically coupled to the first dc-dc converter, and configured to be charged or discharged, directly or indirectly via the output node,
wherein the charging circuit further comprises a second dc-dc converter electrically coupled in series between the programmable power supply circuit and the battery, wherein one of the first dc-dc converter and the second dc-dc converter is an unregulated converter.

5. The power converter of clause 4, wherein the first dc-dc converter and the second dc-dc converter are configured to operate simultaneously.

6. The power converter of clause 4 or clause 5, further comprising:
a boost converter or a charge pump converter coupled between the battery and the output node.

7. The power converter of any of clauses 4-6, wherein, in a discharging phase of the battery, the second dc-dc converter is configured to convert a battery voltage outputted by the battery to a first voltage received by the first dc-dc converter, and the first dc-dc converter is configured to regulate and provide the system output voltage, in response to the first voltage from the second dc-dc converter.

8. The power converter of any of clauses 4-7, wherein, in a charging phase of the battery, the first dc-dc converter is configured to provide the system output voltage, in response to the regulated DC input voltage from the programmable power supply circuit, and the second dc-dc converter is configured to provide a charging voltage to the battery, in response to the regulated DC input voltage from the programmable power supply circuit.

9. The power converter of any of clauses 4-8, further comprising:
a charger transistor electrically coupled in series between the first dc-dc converter and the battery via the output node and configured to enable or disable charging or discharging of the battery.

10. The power converter of clause 9, further comprising:
a switch device electrically coupled in parallel to the charger transistor and configured to bypass the charger transistor when the switch device is closed.

11. The power converter of clause 9 or clause 10, wherein the charger transistor is electrically coupled between the first dc-dc converter and the second dc-dc converter.

12. A power converter for use with a programmable power supply circuit, comprising:
a charging circuit electrically coupled to the programmable power supply circuit, the programmable power supply circuit being configured to provide a regulated DC input voltage, the charging circuit comprising:
   a first dc-dc converter electrically coupled to the programmable power supply circuit and configured to convert the regulated DC input voltage to a system output voltage at an output node;
a battery electrically coupled to the first dc-dc converter, and configured to be charged or discharged, directly or indirectly via the output node;
wherein the charging circuit further comprises a second dc-dc converter electrically coupled in series between the programmable power supply circuit and the battery, and the first dc-dc converter and the second dc-dc converter are configured to operate simultaneously.

13. The power converter of clause 12, wherein the first dc-dc converter and the second dc-dc converter are electrically coupled in parallel.

14. The power converter of clause 12 or clause 13, further comprising:
a charger transistor electrically coupled in series between the first dc-dc converter and the battery via the output node and configured to enable or disable charging or discharging of the battery.

15. The power converter of clause 14, further comprising:
a switch device electrically coupled in parallel to the charger transistor and configured to bypass the charger transistor when the switch device is closed.

16. The power converter of clause 14 or clause 15, wherein the charger transistor is electrically coupled between the first dc-dc converter and the second dc-dc converter.

17. A power converter for use with a programmable power supply circuit, comprising:
a charging circuit electrically coupled to the programmable power supply circuit, the programmable power supply circuit being configured to provide a regulated DC input voltage, the charging circuit comprising: a first dc-dc converter electrically coupled to the programmable power supply circuit and configured to convert the regulated DC input voltage to a system output voltage at an output node; and
a battery electrically coupled to the first dc-dc converter, and configured to be charged or discharged, directly or indirectly via the output node,
wherein the charging circuit further comprises a boost converter or a charge pump converter electrically coupled between the battery and the output node.

18. The power converter of clause 17, wherein the charging circuit further comprises a second dc-dc converter electrically coupled in series between the programmable power supply circuit and the battery.

19. A power converter for use with a programmable power supply circuit, comprising:
a charging circuit electrically coupled to the programmable power supply circuit, the programmable power supply circuit being configured to provide a regulated DC voltage as a system output voltage at an output node, the charging circuit comprising: a first dc-dc converter electrically coupled to the programmable power supply circuit at the output node, and configured to perform a voltage conversion between the system output voltage and a battery voltage; and
a battery electrically coupled to the first dc-dc converter, and configured to be charged or discharged, directly or indirectly, based on the battery voltage.

20. The power converter of clause 19, further comprising:
a charger transistor electrically coupled in series between the first dc-dc converter and the battery and configured to enable or disable charging or discharging of the battery.

21. The power converter of clause 20, further comprising:
a first switch device electrically coupled in parallel to the charger transistor and configured to bypass the charger transistor when the first switch device is closed.

22. The power converter of clause 20 or clause 21, further comprising:
a second switch device electrically coupled in parallel to the first dc-dc converter and configured to enable a direct charging or discharging between the battery and the output node when the second switch device is closed.

23. The power converter of any of clauses 20-22, further comprising:
a second dc-dc converter electrically coupled between the programmable power supply circuit and the charger transistor.

24. The power converter of clause 23, wherein one of the first dc-dc converter and the second dc-dc converter is an unregulated converter, and the other one of the first dc-dc converter and the second dc-dc converter is a regulated converter.

25. The power converter of clause 23 or clause 24, wherein the charger transistor is electrically coupled between the first dc-dc converter and the second dc-dc converter.

26. The power converter of any of clauses 23-25, wherein the first dc-dc converter and the second dc-dc converter are electrically coupled in parallel.

27. A method for charging and discharging a battery, comprising:
during a first period, converting, by a first dc-dc converter electrically coupled to a programmable power supply circuit, a regulated DC input voltage to a system output voltage at an output node;
during a charging period of the first period, charging a battery electrically coupled to the first dc-dc converter, directly or indirectly via the output node, based on the system output voltage; and
during a second period, discharging the battery to provide the system output voltage, via the output node,
wherein the regulated DC input voltage is outputted by the programmable power supply circuit during the first period.

28. The method of clause 27, further comprising:
enabling or disabling charging or discharging of the battery via a charger transistor electrically coupled in series between the first dc-dc converter and the battery via the output node.

29. The method of clause 28, further comprising:
during the charging period or the second period, closing a switch device electrically coupled in parallel to the charger transistor to bypass the charger transistor.

30. The method of clause 28 or clause 29, further comprising:
operating the first dc-dc converter and a second dc-dc converter electrically coupled in series between the programmable power supply circuit and the battery simultaneously to provide the system output voltage at the output node.

31. The method of clause 30, wherein operating the first dc-dc converter and the second dc-dc converter comprises:
during the second period, converting, by the second dc-dc converter, a battery voltage outputted by the battery to a first voltage; and
regulating the first voltage, by the first dc-dc converter, to provide the system output voltage.

32. The method of clause 30 or clause 31, wherein operating the first dc-dc converter and the second dc-dc converter comprises:
during the charging period, regulating and providing the system output voltage, by the first dc-dc converter, in response to the regulated DC input voltage from the programmable power supply circuit; and
providing a charging voltage to the battery, by the second dc-dc converter, in response to the regulated DC input voltage from the programmable power supply circuit.

33. The method of any of clauses 30-32, wherein one of the first dc-dc converter and the second dc-dc converter is an unregulated converter.

34. The method of any of clauses 30-33, wherein the charger transistor is electrically coupled between the first dc-dc converter and the second dc-dc converter.

35. The method of any of clauses 30-34, wherein the first dc-dc converter and the second dc-dc converter are electrically coupled in parallel.

36. The method of clause 35, further comprising:
during the charging period, closing a switch device electrically coupled in parallel to the charger transistor to bypass the charger transistor.

37. The method of clause 36, further comprising:
during the second period, closing the switch device to bypass the charger transistor to provide the system output voltage from the battery.

38. A method for charging and discharging a battery, comprising:
during a charging period of a first period, charging, by a first dc-dc converter electrically coupled to a programmable power supply circuit at an output node, a battery electrically coupled to the first dc-dc converter, directly or indirectly via the output node, based on a system output voltage by performing a voltage conversion between the system output voltage and a battery voltage of the battery; and
during a second period, discharging the battery to provide the system output voltage, via the output node,
wherein the system output voltage is a regulated DC voltage outputted by the programmable power supply circuit at the output node during the first period.

39. The method of clause 38, further comprising:
enabling or disabling charging or discharging of the battery via a charger transistor electrically coupled in series between the first dc-dc converter and the battery via the output node.

40. The method of clause 39, further comprising:
during the charging period or the second period, closing a first switch device electrically coupled in parallel to the charger transistor to bypass the charger transistor.

41. The method of clause 39 or clause 40, further comprising:
during the charging period or the second period, closing a second switch device electrically coupled in parallel to the first dc-dc converter to enable a direct charging or discharging between the battery and the output node.

42. The method of any of clauses 39-41, further comprising:
operating the first dc-dc converter and a second dc-dc converter electrically coupled between the programmable power supply circuit and the charger transistor, wherein one of the first dc-dc converter and the second dc-dc converter is an unregulated converter, and the other one of the first dc-dc converter and the second dc-dc converter is a regulated converter.

43. The method of clause 42, wherein the charger transistor is electrically coupled between the first dc-dc converter and the second dc-dc converter.

44. The method of clause 42 or clause 43, wherein the first dc-dc converter and the second dc-dc converter are electrically coupled in parallel.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1.-3. (canceled)

4. A power converter for use with a programmable power supply circuit, comprising:
a charging circuit electrically coupled to the programmable power supply circuit, the programmable power supply circuit being configured to provide a regulated DC input voltage, the charging circuit comprising: a first dc-dc converter electrically coupled to the programmable power supply circuit and configured to convert the regulated DC input voltage to a system output voltage at an output node; and
a battery electrically coupled to the first dc-dc converter, and configured to be charged or discharged, directly or indirectly via the output node,
wherein the charging circuit further comprises a second dc-dc converter electrically coupled in series between the programmable power supply circuit and the battery, wherein one of the first dc-dc converter and the second dc-dc converter is an unregulated converter.

5. The power converter of claim 4, wherein the first dc-dc converter and the second dc-dc converter are configured to operate simultaneously.

6. The power converter of claim 4, further comprising:
a boost converter or a charge pump converter coupled between the battery and the output node.

7. The power converter of claim 4, wherein, in a discharging phase of the battery, the second dc-dc converter is configured to convert a battery voltage outputted by the battery to a first voltage received by the first dc-dc converter, and the first dc-dc converter is configured to regulate and provide the system output voltage, in response to the first voltage from the second dc-dc converter.

8. The power converter of claim 4, wherein, in a charging phase of the battery, the first dc-dc converter is configured to provide the system output voltage, in response to the regulated DC input voltage from the programmable power supply circuit, and the second dc-dc converter is configured to provide a charging voltage to the battery, in response to the regulated DC input voltage from the programmable power supply circuit.

9. The power converter of claim 4, further comprising:
a charger transistor electrically coupled in series between the first dc-dc converter and the battery via the output node and configured to enable or disable charging or discharging of the battery.

10. The power converter of claim 9, further comprising:
a switch device electrically coupled in parallel to the charger transistor and configured to bypass the charger transistor when the switch device is closed.

11. The power converter of claim 9, wherein the charger transistor is electrically coupled between the first dc-dc converter and the second dc-dc converter.

12. A power converter for use with a programmable power supply circuit, comprising:
a charging circuit electrically coupled to the programmable power supply circuit, the programmable power supply circuit being configured to provide a regulated DC input voltage, the charging circuit comprising:
a first dc-dc converter electrically coupled to the programmable power supply circuit and configured to convert the regulated DC input voltage to a system output voltage at an output node;
a battery electrically coupled to the first dc-dc converter, and configured to be charged or discharged, directly or indirectly via the output node;
wherein the charging circuit further comprises a second dc-dc converter electrically coupled in series between the programmable power supply circuit and the battery, and the first dc-dc converter and the second dc-dc converter are configured to operate simultaneously.

13. The power converter of claim 12, wherein the first dc-dc converter and the second dc-dc converter are electrically coupled in parallel.

14. The power converter of claim 12, further comprising:
a charger transistor electrically coupled in series between the first dc-dc converter and the battery via the output node and configured to enable or disable charging or discharging of the battery.

15. The power converter of claim 14, further comprising:
a switch device electrically coupled in parallel to the charger transistor and configured to bypass the charger transistor when the switch device is closed.

16. The power converter of claim 14, wherein the charger transistor is electrically coupled between the first dc-dc converter and the second dc-dc converter.

17.-18. (canceled)

19. A power converter for use with a programmable power supply circuit, comprising:
a charging circuit electrically coupled to the programmable power supply circuit, the programmable power supply circuit being configured to provide a regulated DC voltage as a system output voltage at an output node, the charging circuit comprising: a first dc-dc converter electrically coupled to the programmable power supply circuit at the output node, and configured to perform a voltage conversion between the system output voltage and a battery voltage; and
a battery electrically coupled to the first dc-dc converter, and configured to be charged or discharged, directly or indirectly, based on the battery voltage.

20. The power converter of claim 19, further comprising:
a charger transistor electrically coupled in series between the first dc-dc converter and the battery and configured to enable or disable charging or discharging of the battery.

21. The power converter of claim 20, further comprising:
a first switch device electrically coupled in parallel to the charger transistor and configured to bypass the charger transistor when the first switch device is closed.

22. The power converter of claim 20, further comprising:
a second switch device electrically coupled in parallel to the first dc-dc converter and configured to enable a direct charging or discharging between the battery and the output node when the second switch device is closed.

23. The power converter of claim 20, further comprising:
a second dc-dc converter electrically coupled between the programmable power supply circuit and the charger transistor.

24. The power converter of claim 23, wherein one of the first dc-dc converter and the second dc-dc converter is an unregulated converter, and the other one of the first dc-dc converter and the second dc-dc converter is a regulated converter.

25. The power converter of claim 23, wherein the charger transistor is electrically coupled between the first dc-dc converter and the second dc-dc converter.

26. The power converter of claim 23, wherein the first dc-dc converter and the second dc-dc converter are electrically coupled in parallel.

27.-44. (canceled)
